(19) United States
(12) Patent Application Publication
(10) Pub. No.: US 2007/0261226 A1
(43) Pub. Date: Nov. 15, 2007

(54) Marine riser and method for making

(75) Inventors: Hans H. J. Deul, Richmond, TX (US); Thomas E. Prosser, Houston, TX (US)

Correspondence Address: RICHARD A. FAGIN, P.O. BOX 1247, RICHMOND, TX, 77406-1247, US

(73) Assignee: Noble Drilling Services Inc.

(21) Appl. No.: 11/430,812

(22) Filed: May 9, 2006

(51) Int. Cl. B23P 11/00; B23P 17/00

(52) U.S. Cl. 29/525.13; 29/525.14

(57) ABSTRACT

A method for forming an aluminum alloy riser includes forming a riser tube from an aluminum alloy. At least one flanged coupling is formed from the aluminum alloy. The flanged coupling is friction stir welded to one end of the tube. In one embodiment, an end of the tube is radially plastically expanded prior to welding the flange to the one end of the tube.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of apparatus for drilling wellbores from floating drilling structures. More specifically, the invention relates to structures for and methods for making marine riser to couple a wellbore from the sea floor to a floating structure on the surface of the water.

2. Background Art

Floating offshore hydrocarbon production platforms, such as semi-submersible drilling platforms and dynamically positioned drill ships, are used to drill wellbores through Earth formations below the bottom of a body of water such as a lake or the ocean. The wellbores are typically used in the production of hydrocarbons from the subsurface Earth formations. A pipe called a “riser” is typically provided between the floating drilling platform and a control device at the top of the wellbore called a “wellhead” disposed near the water bottom. The riser provides a closed path for fluids from the wellbore to the floating drilling platform.

A conventional marine drilling riser comprises a cylindrical pipe or column made of steel, and is assembled from a plurality of sections or “joints” connected end to end in a “string” between the floating drilling platform and the wellhead. The assembled portion of the riser is typically suspended by equipment on the floating drilling platform and is lowered into the water as new joints are assembled to the top of the riser on board the floating drilling platform. Buoyancy modules are typically fitted to the riser to reduce its submerged weight. When the riser is substantially completed, it is coupled to the wellhead and tension is then applied to the top of the riser string to prevent buckling of the riser string due to the weight of fluid in the bore of the riser and due to sea currents.

Steel riser has proven to be a reliable, effective conduit material for creating a closed path from the wellbore to the floating drilling structure. A consideration in designing the floating platform for use in any particular water depth is its carrying capacity, because the floating platform must be able to withdraw the riser from the water, disassemble it and store it on the platform when the platform is moved to another well location. Steel is relatively dense, and therefore has significant weight per unit length. A steel pipe with adequate wall thickness to meet burst and collapse pressure requirements for a drilling or production riser therefore adds significant weight to the floating platform. The weight of the riser can substantially limit the payload capacity of the floating platform that is available for other necessary equipment and personnel. Existing platforms therefore can only carry a limited number of riser sections without exceeding their maximum load limit. Therefore, floating drilling platforms, for any given buoyancy capacity, are subject to limits to the depth in which they can operate based on the weight of riser that can be safely carried by the platform.

An increasing demand for drilling in greater water depth has required additional riser pipe to be used in order to span the distance from the ocean floor to the floating drilling platform. Consequently, using a conventional steel riser at greater depths of water requires sacrificing valuable payload capacity to carry the necessary riser pipe, or increasing the size of the platform to accommodate the extra riser weight. In addition, the added weight of a steel riser can increase the amount of fuel consumption during operations and therefore increase costs of operations.

The use of a lighter weight material such as titanium is known in the art. The high cost of titanium, however, is a significant disadvantage that renders its use impractical. U.S. Pat. No. 6,415,867 issued to Deul et al and assigned to the assignee of the present invention, describes a method for making marine drilling riser from aluminum alloy made in the Russian Federation known by number 1980.

The aluminum alloy riser disclosed in the Deul et al. '867 patent has proven very useful in enabling floating drilling platforms to operate in greater water depth than would be possible using conventional steel riser. As a practical matter, such riser is believed to be safely and reliably operable in water depths of up to about 6,000 feet (2,000 meters). There exists a need for riser to be operable in water depths of 10,000 feet (3,000 meters) or more. Direct adaptation of the riser and method for making disclosed in the Deul et al. '867 patent to produce a riser capable of operating in such water depths could be effected simply by increasing the wall thickness of the riser pipe itself, such that the tensile load capacity of the riser is correspondingly increased. However, such increase in wall thickness would substantially increase the weight per unit length of such riser, which would substantially reduce the weight advantage offered by the aluminum alloy riser disclosed in the Deul et al. '867 patent.

There continues to be a need for riser that enables operations in ever greater water depth without corresponding increase in the deckload capacity of a floating drilling rig.

### SUMMARY OF THE INVENTION

One aspect of the invention is a method for forming an aluminum alloy riser. The method includes forming a riser tube from an aluminum alloy. At least one flanged coupling is formed from the aluminum alloy. The flanged coupling is friction stir welded to one end of the tube.

In one embodiment, the method further includes plastically radially expanding the end of the tube prior to the friction stir welding. In one embodiment, the method includes heat treating the weld. In one embodiment, the weld is treated by thermal spray aluminum.

In one embodiment, the heat treating includes heating proximate the weld to about one hundred ten degrees Celsius at a rate of at most about twenty degrees Celsius per hour, then heating to about one hundred fifty degrees Celsius at a rate at most about twenty degrees Celsius per hour, and maintaining the temperature proximate the weld for about three hours.

Other aspects and advantages of the invention will be apparent from the following description and the appended claims.

### BRIEF DESCRIPTION OF THE DRAWINGS

FIG. 1 is a side view of an offshore drilling rig that can be used with a riser made in accordance with one embodiment of the present invention.

FIG. 2 is a partial sectional view of a joint of riser made in accordance with one embodiment of the present invention;.

FIG. 3A is a side view of a flanged coupling in accordance with one embodiment of a riser made using the present invention.

FIG. 3B is a cross-sectional view of the flanged coupling of FIG. 3A.

FIG. 4 is a block diagram of a weld between two cylindrical pipe segments during a heat treating process.

### DETAILED DESCRIPTION

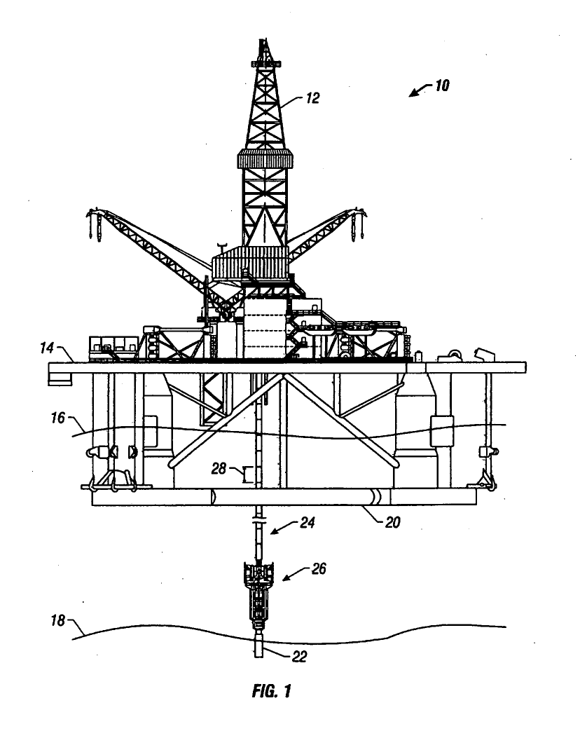

A typical application for a marine riser is shown in FIG. 1. A floating offshore drilling platform or “rig” is designated generally by the numeral 10. While the floating drilling rig 10 is depicted as a semi-submersible drilling platform, it will be appreciated by those skilled in the art that the apparatus, system and method of the present invention find equal application to other types of floating rigs, such as drill ships and the like. Accordingly, the type of drilling rig is not a limitation on the scope of the present invention.

The rig 10 includes a derrick 12 mounted on a floating platform 14. The platform 14 floats near the surface of a body of water 16, such as a lake or the ocean, and is provided with buoyancy by one or more pontoons 20. The water 16 overlays the water bottom 18. The derrick 12 supports equipment (not shown separately) used to drill a wellbore 22 through Earth formations (not shown separately) located below the water bottom 18.

A riser 24 extends from the platform 14 to wellhead equipment and a blowout preventer (BOP) 26, which comprises a series of valves that can close to prevent any unintended escape of fluids from the wellbore 22. The primary functions of the riser 24 are to guide drill pipe and tools (not shown separately in FIG. 1) into the wellbore 22 and to provide a return pathway to the platform 14 for fluid which is pumped into the wellbore 22 from the platform 14.

The riser 24 is assembled from a plurality of substantially cylindrical riser sections or “joints” 28 coupled end to end. It is desirable that each of the riser joints 28 has a high strength-to-weight ratio, such that each riser joint 28 can safely contain the pressure of the fluids enclosed within, as well as accommodate the tensile load caused by the suspension of adjacent riser joints 28. It is also desirable that the riser joints 28 be capable of withstanding the heat and corrosive effects of drilling fluids and formation fluids, as well as the corrosive effects of the water 16 outside the riser 24.

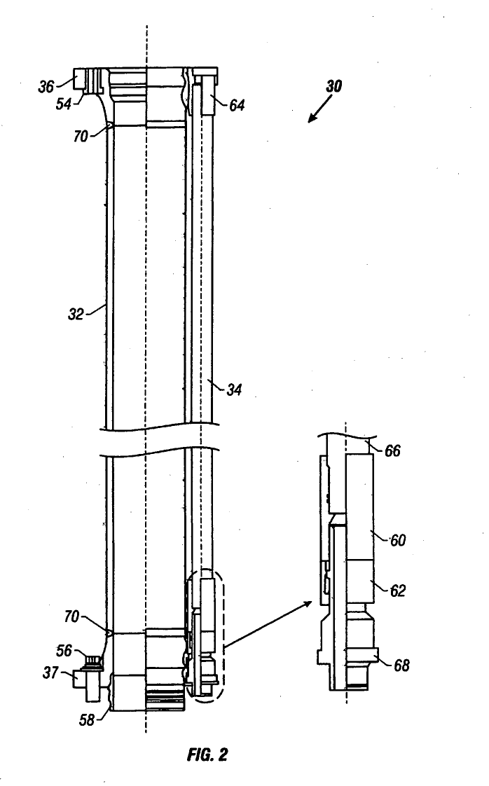

One embodiment of a single riser joint that can be made according to the various aspects of the invention is shown in FIG. 2, and is designated generally by reference numeral 30. The riser joint 30 includes a generally a generally cylindrical pipe 32, one or more auxiliary lines 34, and may also comprise a buoyancy module (not shown for clarity of illustration) coupled externally to the pipe 32. Buoyancy modules (not shown) may be formed from two half cylindrical sections bolted to each other and clamped around the pipe 32.

A first flanged coupling 36 and a second flanged coupling 37 are welded to opposite ends of the pipe 32. The first flanged coupling 36 is depicted in FIG. 2 as a female or “box” coupling, while the second flanged coupling 37 is depicted as a male or “pin” coupling. Preferably, the pipe 32, the first flanged coupling 36 and the second flanged coupling 37 are manufactured from an aluminum alloy made in the Russian Federation and known by alloy number 1953.

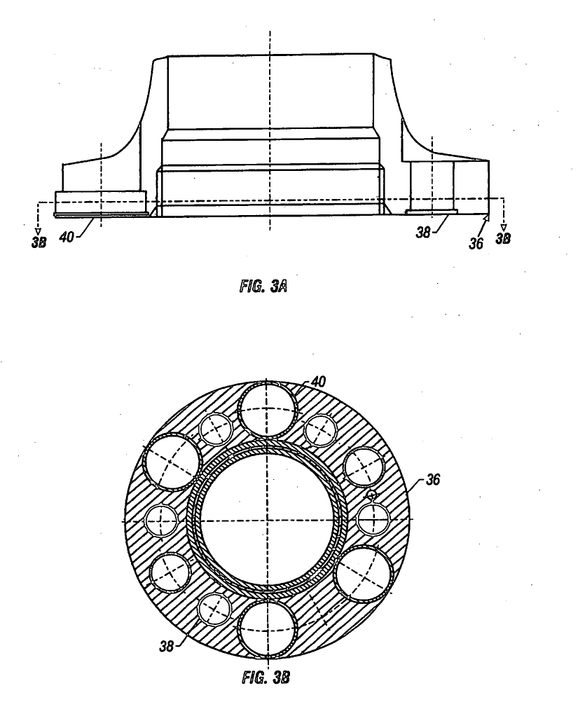

A side view of the first flanged coupling 36 of FIG. 2 is shown in FIG. 3A, and a cross-sectional view of the first flanged coupling 36 is the in FIG. 3B. The first flanged coupling 36 includes a locking mechanism generally used to securely connect two joints (30 in FIG. 2) of riser together. In the present embodiment, the locking mechanism can include a plurality of bolts and corresponding locations for threaded inserts 38. The first flanged coupling 36 further includes openings 40 for guiding the auxiliary lines 34.

Riser joints constructed according to a preferred embodiment of the present invention exhibit a tensile capacity of approximately 2,500,000 lbs (with substantially zero bending), and a bending capacity of approximately 950,000 fl-lbs (under substantially zero tension). Additionally, a riser joint manufactured from the preferred aluminum alloy number 1953 weighs approximately 17,000 pounds in air. Compared to a conventional steel riser section exhibiting the same tensile capacity and bending capacity yet weighing approximately 22,000 pounds, the riser joint of the present embodiment invention is substantially lighter than an equivalent steel riser joint

Referring again to FIG. 2, the auxiliary lines 34 may include, but are not limited to, choke and kill pipes, hydraulic pipes, and booster pipes. Auxiliary lines 34 are positioned outside the pipe 32, and function to provide hydraulic communication the wellhead equipment and blowout preventer (26 in FIG. 1). The auxiliary lines 34 are also preferably manufactured from the same number 1953 aluminum alloy.

The riser joint 30 of FIG. 2 also includes a threaded insert 54, a bolt 56 and a nose pin 58 for securely coupling two adjacent riser joints 30 together. The riser joint 30 further includes an auxiliary line socket 60, an auxiliary line lock nut 62, an auxiliary line box 64, an auxiliary line pipe 66 and an auxiliary line telescoping pin 68 for securing each auxiliary line 34 in a manner that will be appreciated by those skilled in the art. The telescoping pin 68 effectively functions to provide a gap between the couplings of the riser joints 30 to allow for axial stretching during operation.

In making a riser joint according to one embodiment of the invention, the pipe 32 can be formed by extrusion. Extrusion processing is well known in the art. Typically, the pipe 32 will be about 75 feet (24 m) total length, formed from two, 37½ foot (12 m) long segments welded together end to end. The manner of welding will be further explained below.

The first and second flanged couplings 36, 37, respectively, are typically formed by forging the 1953 alloy, and finish machining the raw forging. Prior to welding the two pipe segments, and prior to affixing the first and second flanged couplings 36, 37, the longitudinal ends of the pipe segments are finished formed by radial plastic expansion over a cylindrical mandrel. In the present embodiment, the expansion is approximately 1.5 percent of the unexpanded diameter of the pipe segment. For one typical size marine drilling riser, the expansion is from about 499 millimeters extruded diameter to a finished diameter of about 506 millimeters. The expansion can be conducted to a length of about 200 millimeters from the longitudinal end of the pipe segment. The purpose for expansion is to provide a substantially round cross section and a substantially uniform wall thickness to the ends of the pipe prior to joining. Extrusion forming, as is the manner of making the pipe segments, typically does not provide the required degree of roundness and uniformity of wall thickness to enable performing the procedure to be described below for affixing the flanged couplings 36, 37 to the pipe ends, and joining the pipe segments to each other to form the pipe 32. By using radial plastic expansion, the roundness and uniformity of thickness required can be attained with substantially no machining on the inner pipe surface and only minimal machining on the outer pipe surface, with concomitant loss of wall thickness due to machining. Plastic radial expansion also can relieve stresses embedded in the aluminum alloy as a result of the extrusion process, thus further strengthening the pipe in the areas to be joined.

FIG. 2 also shows welds 70 between one end of the pipe 32 and the first flanged coupling 36, and shows corresponding welds 70 between the other end of the pipe 32 and the second flanged coupling 37. In the present embodiment, the welds 70 are formed by a process known as friction stir welding (FSW). FSW can also be used to join the pipe segments as explained above. A suitable FSW technique is disclosed, for example, in U.S. Pat. No. 6,257,479 issued to Litwinski et al. The process is sold commercially under license from the '497 patent owner by Advanced Joining Technologies, Inc., 3030 Red Hill Avenue, Santa Ana, Calif. 92705. For the diameter of riser stated above, the preferred pipe wall thickness is about 32 millimeters. Previously, it was believed that the circumferential FSW process described in the Litwinski et al. patent was usable on pipes having wall thickness of up to about 15 millimeters. It has been determined that the present preferred wall thickness can be welded using the described FSW technique and provide a tensile strength as set forth below.

Following welding of the pipe 32 to the first and second flanged couplings, 36 and 37, respectively, in accordance with one embodiment of the invention, the welds 70 undergo a heat treating process. During the heat treating process, the welds 70 are subjected to local heat treatment which effects change in the molecular structure of the welds 70, which in turn strengthens the welds 70 and the entire riser string.

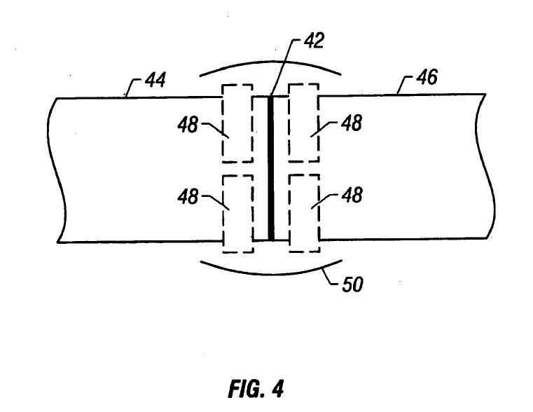

Reference is now made to FIG. 4, which shows a side view of a weld 42 joining two cylindrical pipe segments 44 and 46 as that weld will be subjected to the heat treating process. Heat treating the welds is disclosed in U.S. Pat. No. 6,415,867 issued to Deul et al and assigned to the assignee of the present invention, However, the heat treating process is different when performed on welds created according to the present invention by the FSW process. The heat treating process according to the present embodiment comprises two principal stages. First, weld 42 is subjected to heaters at a temperature of approximately 110 degrees C. As shown in FIG. 4, a plurality of heaters 48 are brought in close proximity to weld 42. In one embodiment of the present invention, four semi-circular heaters 48 surround weld 42 and are used to uniformly apply heat to the weld 42. The heaters 48 are surrounded by insulation 50. The heaters 48 can be controlled by a microcontroller or microprocessor (not shown) that can be programmed to perform selected operations. In accordance with the present embodiment of the invention, the heaters 48 are controlled such that temperature is gradually increased at a rate of at most about 20 degrees C./hr. Approximately twelve hours exposure at about 110 degrees C. is sufficient time for this stage.

In the second stage of the heat treating process, the temperature is raised to approximately 150 degrees C. at a rate of at most about 20 degrees C./hr and is then held at that temperature for a selected time. The selected holding time should be approximately twelve hrs. After the holding time has elapsed, the weld 42 is air cooled to ambient temperature. The same heat treating procedure is applicable to the welds (70 in FIG. 2) that join the flanged couplings (36, 37 in FIG. 2) to the ends of the riser pipe (32 in FIG. 2).

After the heat treating process is completed, the weld areas may be treated by a thermal sprayed aluminum (TSA) process. A suitable TSA process is available from Century Corrosion Technologies, Inc., 9710 Telge Road, Houston, Tex. 77095. The TSA process provides additional corrosion protection to the welds 70, 42.

In some embodiments, the pin end (auxiliary line telescoping pin 68) may be hardfaced to increase wear resistance. Each riser joint may also be painted prior to use for additional corrosion protection.

A possible benefit offered by the described process for forming aluminum riser is that the riser pipe and the flanged couplings may be made from the same material, and the welds are formed without introducing a dissimilar material into the riser joint. By using identical materials for the pipe and the flanged couplings, and the weld thereto, galvanic corrosion damage may be substantially reduced as compared with aluminum alloy riser components made with dissimilar materials.

It has been determined that forming a riser joint as explained above can provide a weld joint with a tensile strength of at least 80 percent, and preferably more than 90 percent of the tensile strength of the aluminum alloy itself. Such weld strength makes it possible to retain much of the weight advantage provided by using aluminum for a riser as contrasted with steel, even for expected water depths of 10,000 feet or more.

The foregoing description of the invention is made in terms of marine drilling riser. However, it is to be understood that any segmented, flange-coupled, fluid carrying aluminum conduit that is intended to traverse a large vertical distance and will be supported in tension at the upper end thereof may make use of the manufacturing process and structure disclosed herein. As one particular example, a so called production riser that couples a wellhead to a floating production platform such as a “tension leg” platform may also make use of the invention. Accordingly, the invention is not limited to use as drilling riser.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for forming an aluminum alloy riser, comprising:
forming a riser tube from an aluminum alloy;
forming at least one flanged coupling from the aluminum alloy; and
friction stir welding the at least one flanged coupling to one and of the tube.

2. The method of claim 1 further comprising plastically radially expanding the one end of the riser tube prior to the friction stir welding.

3. The method of claim 2 wherein the expanding increases the diameter of the tube by about one and one half percent of the unexpanded diameter of the tube.

4. The method of claim 1 wherein the tube and the at least one flanged coupling are made from Russian number 1953 aluminum alloy.

5. The method of claim 1 further comprising heat treating the weld created by the friction stir welding.

6. The method of claim 5 wherein the heat treating comprises:
heating proximate the welds to about one hundred ten degrees Celsius at a rate of at most about twenty degrees Celsius per hour;
maintaining the temperature proximate the welds for about twelve hours;
heating to about one hundred fifty degrees Celsius at a rate at most about twenty degrees Celsius per hour; and
maintaining the temperature proximate the welds for about twelve hours.

7. The method of claim 1 further comprising thermal spray aluminum treating the riser.

8. The method of claim 1 wherein the forming the tube comprises extrusion.

9. The method of claim 1 wherein the forming the flanged coupling comprises forging.

10. The method of claim 1 wherein a tensile strength of the weld is at least about eighty percent of a tensile strength of the aluminum alloy.

11. The method of claim 1 wherein a wall thickness of the tube is about 32 millimeters.
